(19) United States
(12) Patent Application Publication
(10) Pub. No.: US 2004/0234659 A1
(43) Pub. Date: Nov. 25, 2004

(54) Method for low pressure, low temperature cooking via the lintonizingTM process

(76) Inventor: David B. Linton, Blacklick, OH (US)

Correspondence Address: ELEY LAW FIRM CO., P.O. BOX 340557, COLUMBUS, OH, 43234-0557, US

(21) Appl. No.: 10/850,919

(22) Filed: May 21, 2004

Related U.S. Application Data
(60) Provisional application No. 60/472,547, filed on May 21, 2003.
(60) Provisional application No. 60/533,699, filed on Dec. 30, 2003.

(51) Int. Cl. A23L 1/27

(52) U.S. Cl. 426/509

(57) ABSTRACT

A process for low pressure, low temperature cooking raw vegetables, such as potatoes peppers, corn, onions, peas, yams, carrots, broccoli, eggplant and squash. The process includes cleaning the raw vegetables, rinsing them, blanching them, removing excess water from the vegetables, subjecting the vegetables to a significant vacuum while still heated from the blanching process, removing the vacuum from the vegetables and then packaging the processed vegetables for subsequent use and/or further preparation.

### CROSS REFERENCE TO RELATED APPLICATIONS

This application claims the benefit of U.S. Provisional Application No. 60/472,547, filed May 21, 2003 and U.S. Provisional Patent Application No. 60/533,699, filed Dec. 30, 2003.

### FIELD OF THE INVENTION

This invention relates to food processing and, more particularly, to a process for pre-processing foodstuffs containing substances including starches, cellulose, pectin, and/or naturally occurring sugars and enzymes, such as potatoes, corn, peppers, onions, carrots, broccoli, squash and other vegetables, for subsequent further processing and consumption.

### BACKGROUND OF THE INVENTION

Commercially available pre-processed vegetables typically are prepared by first cutting (peeling and coring if required) whole vegetables into portions, such as wedges, slices, strips, shreds or rices then blanching those portions in hot water or steam, followed by cooling in air or water (emersion or deluge) and finally freezing. The frozen vegetable portions may then be re-thermed/reheated by the end user, typically a restaurant, as an ingredient or by means common to restaurant/commissary kitchens such as boiling, steaming, stir frying, grilling, roasting or sauteing, as by way of example. Other re-therming/reheating methods include oven heating and microwave heating. Most prior processes use variations of the foregoing pre-process, including additional steps, to prepare vegetable products for freezing and shipment to the consumer.

Commercially prepared potatoes typically are prepared by cutting whole potatoes into portions, such as wedges or strips, American “fries” or English “chips,” blanching those portions in hot water or steam, drying the strips in hot air, then par frying the portions in hot oil prior to freezing them. The frozen potato portions may then be reconstituted by the consumer, typically a restaurant, by frying them in oil or heating them in either a conventional or microwave type oven. Many prior processes use variations of the foregoing process, including some having additional process steps, to prepare potato products to be frozen for shipment to the consumer

In the alternative, fresh vegetables may be cleaned, cut and refrigerated in their raw state (without blanching) and then sold to similar businesses. This abbreviated process produces what is known as “fresh” product. Fresh product has the disadvantage of having a relatively short shelf life and reduced quality due to internal enzymatic action within the product, as well as degradation at the hands of spoiling agents.

In the case of vegetables, the vast majority of products are either processed for immediate use, short-term storage or long-term frozen storage. While desirable, long-term storage (>30 days) of processed, but unfrozen vegetable portions having acceptable organoleptic qualities has been difficult to achieve. Some of these prior processes are described below.

“Immediate use” vegetable products are harvested, cleaned of unusable vegetable matter and field debris, hand packaged and then cooled. Typically, this process takes place in or near the field where the vegetable products are harvested. These products are then typically transported directly to produce wholesalers, who then resell them to local retail, restaurant and commissary operations. Such fresh vegetables have a relatively short shelf life and, in many cases, still suffer significant degradation prior to their reaching the final customer. This means that the intended attributes of freshness are not enjoyed by the final customer. Evidence of this can be seen by the wilted and withered appearance typical of stale vegetables. While preferred for their flavor, fresh vegetable products require considerably longer preparation time than those that have been pre-processed, thus adding increased operating costs and health risks associated with cutting and hot cooking operations. Fresh vegetable products in this raw state require complete preparation, sanitation and full and complete cooking prior to being consumed safely by end users. Since fresh vegetable products do not cook quickly, the amount of time required to prepare them on-demand for consumption in a restaurant environment would certainly over tax the patience of most patrons.

In contrast, short term stored products are similar to the above but withstand the vagaries of storage primarily due to their harvest prior to full maturity, original product quality or optimized storage facilities. Premium quality products are stored on a longer term basis in specifically designed high humidity, low oxygen, low temperature environments that minimize enzymatic action caused by ambient temperature and moisture optimization via non-condensing near saturation conditions. While this methodology of storage allows vegetable products to be stored for longer periods of time, it is very expensive and is limited in its capacity. Unfortunately, vegetable product quality still degrades over time despite of following this storage method and corresponding investment.

The processing of vegetable products for long-term storage as taught by traditional methods begins by removing excess vegetable matter, field debris and other unusables from the product. Incoming raw product is then washed and, in some cases such, as potatoes, carrots, onions and sweet potatoes (yams), peeled. Other products, such as peppers, are cored. Depending upon the final desired product, further processing may include slicing or sectioning. Generally slices range from thin, 1/32 inch slices to thick slices over two inches, whereas sectioned units can range from 2 to over 12 per vegetable unit or even take the form of shreds or rices, for example. Sliced or sectioned pieces then are typically blanched in mediums that include a water bath, a water deluge, heated saturated air environment, microwave energy or live, high temperature steam. Following the blanching process, the product is cooled via water bath, water deluge or chilled using saturated air passing through a bed of the blanched product. Once the product has cooled down it is typically frozen by conventional means. Industrial systems pass air, usually in the range of −20 to −40° F., through a bed of product to achieve freezing of the product. After freezing, the product is then packaged for storage. Generally, freezing increases the shelf life of the product rendering it more marketable and easier to ship and store.

In the case of preparing of potato portions, the vast majority of traditional processes include at least one par frying step. During par frying, the potato portions typically are immersed in a tank of hot cooking oil or fat. Alternative frying methods may be used such as “deluge” frying wherein hot frying oil is sprayed downwardly or caused to cascade downwardly onto the potato portions as they are conveyed beneath the cooker. The frying oil, which typically has a temperature of 350° F. to 375° F., partially cooks the potato portions, driving out moisture and thereby increasing the solids percentage of those portions. Removal of moisture from the potato portions is also desirable in order to reduce hydrolysis of the cooking oil, thus prolonging its useful life. Unfortunately, the par frying step, while effective to quickly remove moisture content from potato portions, is a relatively harsh means for extracting moisture, especially at higher frying temperatures, thus adversely affecting the organoleptic qualities of the ultimate prepared potato product.

While the traditional methods of fresh vegetable preparation, packaging and cooling allow for shipping with a modicum of short-term storability, they neither stop enzymatic activities nor optimize inter- and intra-cellular stabilization. Failure to stop enzymatic activities and optimize cell stability results in reduced shelf life, degradation in product appearance, such as discoloration and wilting, and increased efforts by end users expended in preparing the vegetables for the final customers. Additionally, waste is increased due to the aforementioned short shelf life due to unacceptable depreciation in the vegetable's appearance, texture, turgor and flavor.

Processing of vegetable products into refrigerated or frozen states traditionally renders a product with characteristics that are not regarded as fresh. Specifically, the product color, texture, turgor and flavor are degraded enough to render the products less desirable than fresh products. Frozen products are also inferior to fresh products because freezing causes the breakdown of the vegetable's inter- and intra-cellular conditions, increased liquid purge and a loss of flavor characteristics.

With respect to potato product, while the traditional steps of high-temperature water (or steam) blanching, par frying and hot air drying facilitate moisture removal and other processing goals, they do not lend themselves to preparation of unfrozen potato portions and may contribute to several undesirable results. For one, over blanching and air-drying tends to cause dust-like potato particles to slough-off during finish frying. As a result, the frying oil tends to chemically break down and cloud up, smoke prematurely, turn rancid, and otherwise shortening the life of the frying oil. Second, flavorings, seasonings and spices tend to volatilize or vaporize in relatively high heat and therefore are “cooked out” of the final product. Third, high-temperature frying or use of potatoes having high sugar content can result in the portions becoming a darkened brown color due to the Maillard reaction which involves a reaction between reducing sugars and amino acids. To combat this effect, it has traditionally become necessary to start with high-quality potatoes having fewer reducing sugars. This need becomes even more compelling for frozen potato products designed to have a high solids content. Fourth, some potato flavor is lost as flavor components are degraded and/or volatilized in frying oil heated to a high temperature. This problem is even more acute with “low solids” potato products which require longer, more extensive processing. Lastly, fry time of frozen vegetables, such as potatoes, is longer than that for unfrozen.

Many of the foregoing consequences are exacerbated in conventional processes designed to allow vegetable products to be stored for short to long intervals. Manufacturers seek to increase efficiency, reduce labor, and effectuate reconstitution. However, these are trade offs at the cost of degraded flavor, color and mouth feel (texture and turgor). Properly processed, optimal quality product is only attainable from vegetable products that are premium in terms of quality attributes. Unfortunately, these products are very costly and of limited availability because of the logistics of getting them from the harvest field onto the customer's table. In addition, trying to preserve the nature of the fresh vegetables may dictate processing on a regional basis in order to maintain short shipping times and proper shipping environments. All of which makes the products expensive in spite of quality attributes that will still degrade markedly over time.

The use of vacuum processes is well-known throughout the food processing industry. Specifically, vacuum infusion is used for the introduction of flavors and property enhancers for vegetable portions as well as some types of meat. This is done by placing the food portion in a chamber subjecting it to a vacuum and then introducing various flavorings and property enhancers that, due to the vacuum, penetrate into the pores of the treated portion when the vacuum is removed. Vacuum infusion may be employed to treat foodstuffs with various antibacterial and/or anti-fungicidal agents, as well.

Goldberg et al., in U.S. Pat. No. 6,245,291, discusses the application of biocidal treatment to whole muscle meats, processed meats and various fruits as well as porous and nonporous foodstuffs. The focus of which is the destruction of bacteria and spore formers that are toxic to humans. Of particular interest is the use of vacuum to induce movement of the biocidal or non-biocidal substances. The focus of the disclosed process is the minimization of perceptible changes to the subject product by the end user. This is in contrast with the optimization of quality, attributes and storability that is not dependant on agents such as biocides.

A vacuum environment is specifically claimed in the embodiment by Haamer, in U.S. Pat. Publ. No. US2003/0017238, where food or similar product to be processed or sterilized is packaged in a suitable flexible medium, such as plastic, and then heated with microwave or radio wave energy. The package is designed with a vented relief valve that allows for escape of gases during heating. At the termination of the heating cycle, the vent closes during cooling and a vacuum is formed. This vacuum packaging invention is focused specifically on long-term storage in a vacuum environment.

Some of the problems associated with traditional pre-processing of potato portions have been addressed in the art. Minelli et al., in U.S. Pat. No. 6,514,554, claims vacuum application during par frying and blanching in an oil medium under a vacuum. Neither of these processes lends themselves to the preparation of potato and/or vegetable portions that can be packaged, shipped and prepared by the end user as a “fresh”, unfrozen, vegetable product. Rather, Minelli focuses on in-vessel processing with water or oil mediums to attain the desired characteristics. It is well understood that this is a very expensive process system in terms of both operational costs and investment funding and does not produce the most desirable vegetable characteristics.

With respect to potato portions that comprise the common American-style potato chip, these products generally: require the use of a more expensive raw potato in order to avoid dark brown product; are expensive to ship because of their bulk to weight ratio; are subject to breakage during transit; and can vary widely in freshness depending upon how long they are stored prior to use. These are undesirable product characteristics that manufacturers and operators would like to see eliminated.

The fresh produce industry uses vacuum cooling to cool cleaned or freshly harvested fruits and vegetables, including bean sprouts. See article specifically entitled, “Effects of Vacuum Cooling and Storage Temperature on the Quality of Bean Sprouts,” Jennifer R. DeEll et al., ENESAD, France. In such applications, the products are packaged, generally near the point of harvest. The packaging temperature is lowered utilizing various refrigeration techniques and vacuum systems. Product temperature may be near freezing at the completion of the process. This requires fresh unprocessed product that is packaged for distribution the goal being the removal of field heat in preparation for shipping.

In regard to the vacuum cooling of meat for catering systems, Technical Paper No. ICR065, M. Houska et al., describes methodology for subjecting various processed meats to a vacuum system for cooling. This disclosed system approaches only finished, ready-for-distribution meat products. Additionally, infusion of ingredients into the surface of the meat under a vacuum is discussed, which is a common practice in the meat industry.

Zhihang Zhang et al., in an experimental study on temperature and weight loss profiles of vacuum cooling of sliced cooked carrot Technical Paper No. ICR0470, discloses the use of vacuum systems in the cooling of cooked cut carrot slices. In this study it is verified that vacuum cooling is indeed an effective methodology for cooling. Testing was done on a very small lab scale with results being primarily qualitative.

In the paper entitled “Free Volatile Components of Passion Fruit Puree Obtained by Flash Vacuum-Expansion”, P. Brat et al., J. Agric. Food Chem., 48 (12) the authors discuss essence extraction from passion fruit puree. This is quite similar to common multiple effect vacuum induced evaporators available in the art. Volatile essence is extracted from a host medium, generally process puree, then concentrated and reclaimed as a saleable product.

Accordingly, there remains a need in the commercially processed vegetable product industry for a method of preparing whole vegetables and vegetable portions that offers one or more of the following advantages: a longer shelf life so vegetables can be shipped in a “fresh” condition, i.e., without a significant degradation in color and/or loss of texture and turgor; portions that can be prepared quickly and on-demand by the end user with the appearance of being freshly prepared; pre-portioned vegetable products that exhibit resiliency, resist sticking together and that are less susceptible to breakage prior to final cooking or re-therming; retention of much of the vegetable's natural flavors; and reduced time and labor for final preparation. A combination of any one or more of these desirable attributes would yield a vegetable product that is better tasting, more cost effective, more visually appealing, that could be cooked or displayed (i.e., salad bars) on demand and be potentially more nutritious.

### SUMMARY OF THE INVENTION

In brief summary, the present invention comprises an improved pre-process method for preparing “fresh” vegetables, (including potatoes), vegetable and potato portions and the like. As used herein “fresh” shall be used to identify vegetables and vegetable portions that have been processed according to the Lintonizing™ process in contrast to the term “raw”, which is the state of vegetables at the beginning of the Lintonizing™ process. As used herein, the term “vegetable portions” may include whole vegetables as well. In addition to the present invention being applied to vegetables, it is anticipated that the process can be used on some fruits as well and would achieve similar results. Lintonizing™ is a service mark for a proprietary process licensed to Viands Concerted, LLC of Columbus, Ohio.

In one embodiment, peeled and portioned vegetable portions are blanched, drained of excess surface moisture, cooked at a low-temperature and low pressure and then cooled down prior to packaging. In another embodiment, the prepared and portioned vegetables are blanched, drained of excess surface moisture, then cooked at low temperature and low pressure and then treated with flavorings, flavor enhancers and/or preservatives prior to being packaged. In either embodiment, the vegetable portions may be rinsed after cutting and prior to blanching to remove pieces of any cutting residuals from the vegetable surface. To enhance the flavor and appearance of processed vegetables, portions may be grilled or roasted following the low temperature, low pressure cooking process.

The foregoing process produces a high-quality vegetable product that can be shipped refrigerated, has a suitably long shelf life (typically >30 days), produces flavorful, attractive and organoleptically superior finished product, that is, a product that exhibits enhanced vegetable flavor, pleasing color and satisfying firmness. It also provides the food service industry with an exceptional, quick and easy access finished portion that can be re-thermed and/or reheated in a short period of time. Another advantage of the present invention is that it enables the enhancement of organoleptic qualities even from lower grade raw product, thus increasing quality while reducing costs. In some cases fully cooked vegetable portions prepared according to the present invention exhibit the color raw vegetables. As should be recognized by those skilled in the art, other processing advantages and improved product features will also be achieved by the present invention.

### BRIEF DESCRIPTION OF THE DRAWING

Further features of the present invention will become apparent to those skilled in the art to which the present invention relates from reading the following specification with reference to the accompanying drawing, in which:

FIG. 1 is a flow diagram of a process for inter- and intra-cellular stabilization of foodstuffs, and in particular vegetables (including potatoes), according to an embodiment of the present invention.

### DETAILED DESCRIPTION OF A PREFERRED EMBODIMENT

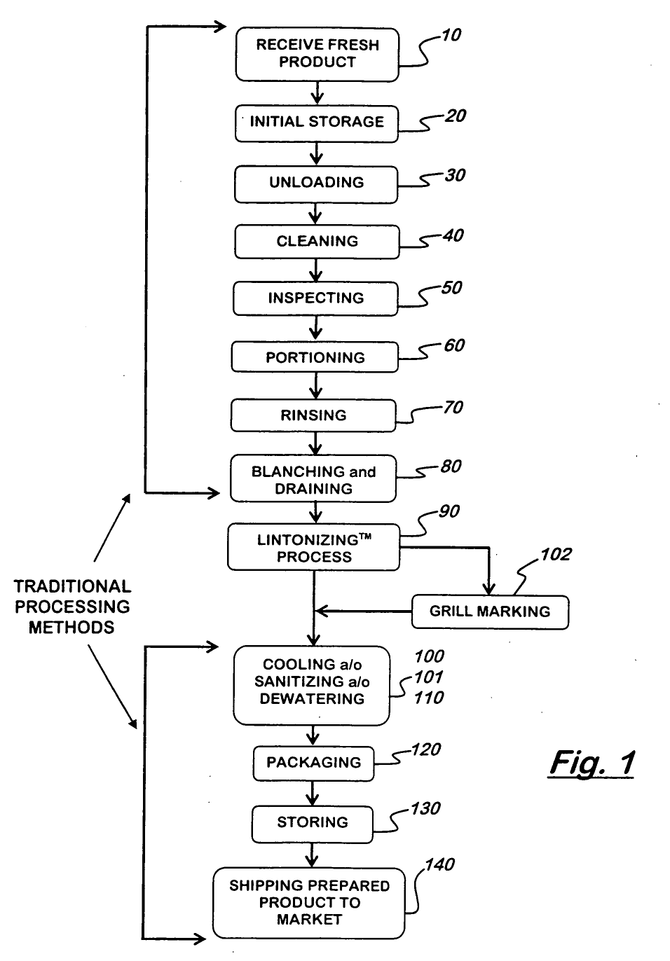

Referring to FIG. 1, in accordance with an embodiment of the present invention, raw vegetables, including without limitation, potatoes, corn, onions, peppers, carrots, squash, egg plant, sweet potatoes, and sugar snap peas, are delivered, stored prior to processing, unloaded, cleaned and inspected for defects, as shown in steps 10 thru 50. Conventional cleaning methods for various products includes husking/de-silking (corn), peeling (root crops) and washing such as with a water plume, flume or spray. The cleaned vegetables may then be cut into portions or pieces suitably sized for the end product as in step 60. As used herein, the term “portions” is used in its broadest sense to include strips or segments, and vegetables cut to specific lengths, as well as substantially whole vegetables, in some cases. Immediately following cutting, the portions may be rinsed, as at step 70, by spraying or immersing the vegetables in a water bath to remove any process-produced debris.

The rinsed vegetable portions are then blanched at step 80 by subjecting them to any number of means, including immersion in hot water, generally at about 165° F. to boiling from about 15 seconds up to 70 minutes, depending upon the characteristics of the vegetable being processed. Blanching may be accomplished by a number of conventional means, such as by immersion, steam, deluge or microwave. With the exception of potatoes and sweet potatoes (yams), a rolling boil water bath for 1 to 5 minutes is utilized, for around 90 seconds preferred. It will be appreciated that the water temperature and immersion time will vary (even outside the noted ranges) depending, among other variables, upon the cut configuration and size of the vegetable portions. In the case of cob corn, altitude consideration will also impact time in the boiling water process. Generally, the blanching step deactivates enzymes present in the vegetables and prevents the vegetables from discoloring during storage.

Alternatively, the vegetable portions may be blanched in steam, using microwave energy or in a deluge blancher at 80. The time and temperature combination for the blanching process is an important part of the process. If the blanching time is too short, such as less than 15 seconds at 165° F., then the portion will be insufficiently heated resulting in enzymes that are not deactivated and leaving bacteria, yeasts and molds that are not adequately neutralized. On the other end of the timing spectrum, if blanched too long, such as 45 minutes or more at 185° F., then the portions will be overcooked, become mushy and too soft to handle. Likewise, blanching the portions at too high a temperature, such as 195° F. or greater, for as long as 70 minutes or more, will cause most vegetable portions to become mushy, discolored and undesirable to the final consumer.

Following the blanching process, the portions are quickly drained of excess surface moisture as at step 80 before further processing. A shaking process or a high velocity fan air knife may be used to rapidly blow off excess surface moisture while trying to retain as much heat in the portions as possible. Such equipment can also be included in the blanching process.

Steps 10 through, and including, step 80 are well known processes within the vegetable processing industry and are shown in FIG. 1 called out with arrows and entitled “Traditional Processing Methods”. Those skilled in the art will quickly recognize these as such. Standard industrial and commercial equipment systems are readily utilized in the processes and will not be discussed in detail here.

The process, according to the present invention, includes transfer of drained vegetable portions to a sealed vacuum chamber in which they are subjected to a vacuum while they are still in a heated state from the prior blanching process, as shown in step 90. The vacuum vessel access door is designed to close and lock. Once the vessel is loaded and locked, a valve opens, allowing the vacuum pressure contained in the system's accumulator to rapidly bring the vessel to a predetermined level of vacuity. If required, a vacuum pump can operate in an automatic mode to further aid in achieving the target vacuity in a short period of time, with about 30 seconds being preferred. While the target vacuum ramp time may vary to cut down on the processing time, it is desirable for the target vacuum to be attained as quickly as possible. The applied vacuum is permitted to ramp up from ambient atmospheric pressure to around 15″ Hg to 30″ Hg where it is maintained in the range of about 15″ Hg to 30″ Hg, preferably about 27.5″ Hg, for a period that can range up to 70 minutes. Depending upon the vacuum source and methodology used, it may take as much as 10 minutes or more to reach the desired level of vacuity. During the vacuum cycle, moisture is extracted from the surface and microstructure of the vegetable portions, part of which immediately vaporizes. The remainder is surface borne liquid and is removed later in the process, as evidenced by accumulation of water in the accumulator and water vapor discharge from the system vacuum pump. As further evidenced by pauses in vacuity rate at approximately 18″ Hg and 21″ Hg, it is believed that the heat of vaporization point is achieved around these two vacuum levels. In contrast, cob corn does not exhibit this phenomenon, wherein the vacuity rate is constant over the entire curve until target vacuum is achieved.

Decompression of the vessel to atmospheric pressure employed at step 90 occurs quickly by the actuation of a relief valve. In one embodiment of the invention, the vacuum vessel at step 90 may additionally comprise a cooling means where the exterior of the vessel is deluge cooled during or following the vacuum cycle. It is believed that the introduction of additional cooling media will further aid the cooling and stabilization of vegetable portions. However, testing has shown that when liquid nitrogen is induced into the vessel at step 90 at the termination of the vacuum cycle, the drastic cooling rate provided by the liquid nitrogen produced a deleterious effect on, not only the surface of the vegetable portion, but also in the micro fibril cellulose structure of the processed vegetable portions.

One desirable benefit of the invention, is that the micro fibril cellulose structure of the vegetable portions is purged of excess water during the low temperature, low pressure cooking process. This results in the toughening of the cell walls and cellulose fibers. This optimizes texture and turgor in the vegetable portions particularly desirable for extended refrigerated storage. It will be appreciated that the actual vacuum parameters are influenced by a number of factors including the physical characteristics of the product portion being processed and target specifications of the final product.

Following the vacuum cycle at step 90, the fresh vegetable portions may be passed through a machine that adds grill or roasting marks, as at 102, to the surface of the vegetable portions. This may be accomplished prior to cooling at 100, including immersion in a water bath, air or mist, having ozone or chlorine dioxide or other bacterial, mold and yeast treating agents. These agents may be supplied via a pump at step 101. In an alternate embodiment the vegetable portions are sprayed with the sanitizing agent just prior to a dewatering process as illustrated at step 110. Pump 101 supplies the sanitizer agent to either process 100 or 110. The vegetable portions are then transferred to a dewatering device 110 where surface water is removed via high velocity air provided by an air stripper or other suitable dewatering device.

Vegetable portions may then packaged at step 120 where excess air may be evacuated the package via a vacuum pump following the introduction of inert gases such as CO₂, N₂ and/or other inert gases appropriate to the particular vegetable portions. Packaged products may then be transported to a warehouse for storage 130 or shipped directly to the consumer, as shown at step 140.

As can be appreciated by those skilled in the art, flavor and texture components of vegetable portions may be significantly degraded during each process phase of the traditional process. This is due primarily to the evaporation of essences and other components in the vegetable that are volatile and the adverse effect on the micro fibril cellulose structure and cellulose treatment. The present low temperature, low pressure cooking process preserves these delicate flavors, color, and texture components for several different product applications because it maximizes water removal within cell structure and strengthens cellular and cellulose fibers even at very low temperatures.

In summary, many advantages are achieved by the present process because the vegetable portions are subjected to processing steps that enhance stored product characteristics through the storage period, aid in simpler safer preparation and are pleasing to the consumer's eye and palate.

### EXAMPLES

### Example 1

This first example illustrates one application of the present invention. The general parameters in this example apply to a cob corn configuration.

Whole cob corn, recently harvested (within 1 to 4 weeks) were received, husked/de-silked, inspected, cut to predetermined lengths and then rinsed to remove surface starch, sugars and residual debris from cutting. The portions were then immersion blanched in boiling water (rolling boil) for about 90 seconds and reaching a core temperature of around 125° F. The portions were removed from the blanch water, shaken to remove excess surface moisture and then directly placed into a vacuum vessel as at 90.

The portions were then subjected to a rapid vacuum, ramping up to 27.5″ Hg over a 22 second period, continuing to cook as the portions cooled down to around 110° F. Following the vacuum process, the cob corn portions were transferred to a water bath enriched with ozonated water and allowed to remain submerged for 3 minutes for the destruction of any mold spores, bacteria or other organic contaminates. The product was then packaged, where specifically designed gas packaging in a flexible medium was completed.

Following around 21 days of storage, the portions prepared in accordance with the process of the present invention were then removed from the packaging and prepared by boiling in water and by microwave heating. The resulting portions were very tender, juicy and tasted sweet with excellent color and minimal wrinkling or puckering of corn kernels, as is typically encountered when reheating cob corn prepared in a traditional manner.

### Example 2

This second example illustrates another application of the present invention. The general parameters in this example apply to a medley of vegetable portions.

A medley of recently harvested whole peppers, onions and zucchini squash were received, cleaned, cored (peppers), peeled (onions), inspected, cut into predetermined portions and then rinsed to remove surface residual debris from coring, peeling and cutting. The medley of vegetable portions was then immersion blanched in boiling (rolling boil) for about 90 seconds until interior product temperature reached around 154° F. The portions were removed from the blanch water, shaken to remove excess surface moisture and then directly placed into a vacuum vessel at step 90.

The portions were then subjected to a vacuum ramping up to around 27.5″ Hg for 23 seconds, where they continued to cook as they cooled down to around 106° F. Following the 23 second vacuum process, the vacuum was released and the portions were transferred to a water bath enriched with ozone and allowed to remain submerged for 3 minutes for treatment of any mold spores, bacteria or related organic contaminates. The medley of vegetable product was then transferred to a flexible, gas-filled packaging medium.

Following a storage period of around 21 days, the portions subjected to the Lintonizing™ process were then removed from their package and reheated, then observed and sampled. The portions were tender, but slightly crunchy, juicy and flavorful with bright color and pleasing appearance. These products were ready for immediate consumption, furthering grilling or as a meal side dish, right out of the package.

### Example 3

This third example illustrates another application of the present invention. The general parameters in this example apply to sliced sweet potato (yam) portions.

Recently harvested whole sweet potatoes were received, peeled, cleaned, inspected, cut in predetermined slices of about ⅙″ in thickness and then rinsed to remove any remaining surface residual debris. The portions were then immersion blanched in 185° F. hot water for about 10 minutes. The yam portions were removed from the blanch water, shaken to remove excess surface moisture and then directly placed into a vacuum vessel 90.

The yam portions then were subjected to a vacuum ramping up to around 27″ Hg and held for 10 minutes. Following the vacuum process the yam portions were submerged in ozone enriched water for 3 minutes, then removed, and excess water shaken off. The portions were then transferred to a deep fat fryer where they were fried for approximately 3 minutes at 350° F.

The yam portions subjected to the Lintonizing™ process were then removed and compared to unprocessed yam portions that had previously been deep-fried. The portions processed according to the present invention exhibited a significant improvement in appearance, texture and mouth feel as compared to the unprocessed portions, which were very dark in color, mottled and had a heavy burnt sugar taste.

### Example 4

This fourth example illustrates another application of the present invention. The general parameters in this example apply to onion portions specifically sectioned into 4 quarter sections.

Recently harvested whole onions were received, peeled, cleaned, inspected, cut to ¼ sections and then rinsed to remove surface residual debris from cutting. Following the blanching, the onion portions were then immersion blanched in boiling water for 30 seconds. The portions were removed from the blanch water, shaken to remove excess surface moisture and then directly placed into vacuum vessel 90.

The onion portions then were subjected to a vacuum ramping up to around 27″ Hg and held for 10 minutes. Following the vacuum process, the onion portions were transferred to an open-flame grilling apparatus and then grilled to a pleasing appearance. For comparison purposes, unprocessed onion sections were grilled as well.

The batches of onion portions were then physically compared and taste tested. The processed onion portions exhibited markedly better flavor appearance (bright), texture and mouth feel, particularly in crispness as compared to the grilled, but unprocessed, onion portions.

### Example 5

This fifth example illustrates yet another application of the present invention. The general parameters in this example apply to vegetable portions, specifically sugar snap peas.

Recently harvested sugar snap peas were received, cleaned and inspected. The pea portions were then immersion blanched in boiling water for 30 seconds. The pea portions were removed from the blanch water, shaken to remove excess surface moisture and then directly placed into a vacuum vessel 90.

The pea portions then were subjected to a vacuum ramping up to about 27″ Hg and held for about 10 minutes. Following the hold time, the vacuum was removed and the processed portions were transferred to a viewing area for side-by-side comparison to pea portions that had undergone only blanching.

The pea portions processed according to the present invention exhibited marked improvements in appearance (bright and colorful), texture and mouth feel, especially crispness, in side-by-side comparison with pea portions processed in the traditional fashion.

### Example 6

This sixth example illustrates another application of the present invention. The general parameters in this example apply to potato portions.

Raw potatoes of the Russet variety were cleaned and then cut into thin slices, appropriately sized for American potato chips. Following their being slices, the portions were rinsed in a cold water bath to remove any debris. The rinsed potato portions where then blanched by immersion into hot water at around 175° F. to 180° F. for a period of about 10 minutes. Following the blanching process, the potato slices are quickly drained and then transferred to a pressure vessel wherein they are subject to a vacuum ramping up from ambient to around 27.5″ Hg. Once the desired vacuity is achieved, the vacuum is removed, bringing the potato portions back to atmospheric pressure. Following the vacuum cooking step, the potato slices were examined and were shown to exhibit a number of desirable characteristics. First, the slices were resilient and were easily handled without breakage. Secondly, the Lintonized™ potato slices exhibited much less stickiness as compared to those processed by traditional means. Further, from a taste standpoint, the processed slices exhibited a pleasing, elevated cooked potato flavor. The potato slices were then transferred to a plastic pouch, evacuated of air and then sealed using an inert gas mixture of nitrogen and carbon dioxide, then refrigerated.

After 21 days the potato slices were removed from their plastic packages and further prepared by deep frying them in hot, relatively inexpensive vegetable oil at 350° F. for about 90-120 seconds. The resulting chip portions were very crisp and had a consistent, light golden color among the multiple chip portions. The portions appeared to absorb very little oil and had a light, delicate and crisp texture with a noticeably pleasant, fresh potato flavor. The fried portions remained crisp even after four days in an ambient, low humidity atmosphere.

Having illustrated and described the principles of the invention with reference to several preferred embodiments, it should be apparent to those of ordinary skill in the art that the invention may be modified in arrangement and detail without departing from such principles.

While the present invention may be used to prepare refrigerated/frozen vegetable products for later re-therming by common restaurant or commissary means, it also may be used to produce products intended to be re-thermed by other methods such as oven heating, roasting, frying, steaming, boiling, grilling, etc.

Accordingly, I claim as my invention all such modifications as come within the true spirit and scope of the forgoing disclosure.

1. A method of preparing raw vegetables for later consumption or processing comprising the steps of:
cleaning the raw vegetables;
rinsing the vegetables;
blanching the vegetables with heated water for a first predetermined time period;
removing excess water from the blanched vegetables;
applying a vacuum to the blanched vegetables to a predetermined level of vacuity while the vegetables are still heated from the blanching process; and
removing the vacuum from the vegetables for consumption or further processing.

2. The method according to claim 1, further comprising the step of dividing the vegetables into at least two portions prior to blanching.

3. The method according to claim 1, wherein the vegetables remain in the vacuum at the predetermined level of vacuity for a second predetermined time period.

4. The method according to claim 1, further comprising the step of packaging the vegetables following the vacuum step under an atmosphere selected from a group of vacuum, ambient air, nitrogen gas, carbon dioxide gas and other inert gases.

5. The method according to claim 1, wherein the vegetables are selected from the group consisting of cob corn, carrots, onions, peas, peppers, broccoli, squash and yams.

6. The method according to claim 1, further comprising the step of introducing flavorings to the vegetables at about the time the vacuum is applied.

7. The method according to claim 1, wherein the vegetables are grilled or roasted following removing them from the vacuum.

8. A method of preparing raw potatoes for later consumption or processing comprising the steps of:
cleaning the raw potatoes;
rinsing the raw potatoes;
blanching the raw potatoes with heated water for a first predetermined time period;
removing excess water from the blanched potatoes;
applying a vacuum to the blanched vegetables to a predetermined level of vacuity while the potatoes are still hot from the blanching process; and
removing the vacuum from the potatoes for consumption or further processing.

9. The method according to claim 8, further comprising the step of dividing the potatoes into at least two portions prior to blanching.

10. The method according to claim 8, wherein the potatoes remain in the vacuum at the predetermined level of vacuity for a second predetermined time period.

11. The method according to claim 8, further comprising the step of packaging the potato product following the vacuum step under an atmosphere selected from a group of vacuum, ambient air, nitrogen gas, carbon dioxide gas and other inert gases.

12. The method according to claim 8, further comprising the step of introducing flavorings to the potatoes at about the time the vacuum is applied.

13. The method according to claim 8, wherein the rinsing comprises a cold rinse.
